(19) United States
(12) Patent Application Publication
(10) Pub. No.: US 2014/0016679 A1
(43) Pub. Date: Jan. 16, 2014

(54) ADAPTIVE CLOCK SPREADING FOR PLATFORM RFI MITIGATION

(71) Applicants: William Dawson Kesling, Davis, CA (US); Harry G. Skinner, Beaverton, OR (US)

(72) Inventors: William Dawson Kesling, Davis, CA (US); Harry G. Skinner, Beaverton, OR (US)

(21) Appl. No.: 13/993,271

(22) PCT Filed: Dec. 30, 2011
(86) PCT No.: PCT/US11/68042

§ 371 Date: Jun. 11, 2013

(51) Int. Cl. H04B 1/7097

(52) U.S. Cl. CPC H04B 1/7097
USPC 375/148

(57) ABSTRACT

An apparatus, system, and method, the method including receiving clock frequency parameter information for at least one clock source; receiving radio parameter information for at least one radio receiver; determining one or more spread spectrum clocking (SSC) profiles for the at least one clock source and the at least one radio receiver, each SSC profile to reduce radio frequency interference between the clock and radio receivers; and storing the SSC profiles.

### BACKGROUND OF THE INVENTION

Electromagnetic interference (EMI) is the disturbance or distortion to an electrical circuit that is caused by electromagnetic induction or radiation from an external source. A number of EMI standards have been imposed by various governmental and/or regulatory agencies to place limits on the amount of EMI that can permissibly be emitted by electronic devices. In response to EMI regulations, spread spectrum clocking (SSC) has been used to reduce the amplitude of the EMI emissions.

In addition to interference that may be caused by external sources, devices having wireless radios may introduce interference to components of the device or platform comprising the wireless radio. This interference is referred to as radio frequency interference (RFI). Additionally, modern devices may include more than one radio, such as a multi-band or “world” phone mobile phone that includes multiple radios to accommodate the differing mobile phone standards in different regions of the world.

As such, there is an increasing need to reduce or eliminate RFI while also maintaining compliance with EMI standards. However, conventional EMI reducing techniques such as SSC do not address RFI considerations. Conventional SSC spreads a signal over a wider frequency spectrum, but such a spread signal may actually overlap frequencies of the radios used by one or more platform radios.

Thus, there is a general need for a method and system for efficient platform RFI mitigation.

### BRIEF DESCRIPTION OF THE DRAWINGS

Aspects of the present disclosure herein are illustrated by way of example and not by way of limitation in the accompanying figures. For purposes related to simplicity and clarity of illustration rather than limitation, aspects illustrated in the figures are not necessarily drawn to scale. Further, where considered appropriate, reference labels have been repeated among the figures to indicate corresponding or analogous elements.

FIG. 1 is a flow diagram of a process, in accordance with one embodiment.

FIG. 2 is a flow diagram of another process, in accordance with one embodiment.

FIG. 3 is an illustrative depiction of a graphical user interface, in accordance with one embodiment.

FIG. 4 is an illustrative depiction of clock parameter data, in accordance with an embodiment.

FIG. 5 an illustrative depiction of radio parameter data, in accordance with an embodiment.

FIG. 6 illustrates a block diagram of an RFI control system, in accordance with some embodiments herein.

### DETAILED DESCRIPTION

The disclosure herein provides numerous specific details such as regarding a system for implementing various processes and operations. However, it will be appreciated by one skilled in the art(s) related hereto that embodiments of the present disclosure may be practiced without such specific details. Thus, in some instances aspects such as control mechanisms and full software instruction sequences have not been shown in detail in order not to obscure other aspects of the present disclosure. Those of ordinary skill in the art will be able to implement appropriate functionality without undue experimentation given the included descriptions herein.

References in the specification to “one embodiment”, “some embodiments”, “an embodiment”, “an example embodiment”, “an instance”, “some instances” indicate that the embodiment described may include a particular feature, structure, or characteristic, but that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Some embodiments herein may be implemented in hardware, firmware, software, or any combinations thereof. Embodiments may also be implemented as executable instructions stored on a machine-readable medium that may be read and executed by one or more processors. A machine-readable storage medium may include any tangible non-transitory mechanism for storing information in a form readable by a machine (e.g., a computing device). In some aspects, a machine-readable storage medium may include read only memory (ROM); random access memory (RAM); magnetic disk storage media; optical storage media; flash memory devices; and electrical and optical forms of signals. While firmware, software, routines, and instructions may be described herein as performing certain actions, it should be appreciated that such descriptions are merely for convenience and that such actions are in fact result from computing devices, processors, controllers, and other devices executing the firmware, software, routines, and instructions.

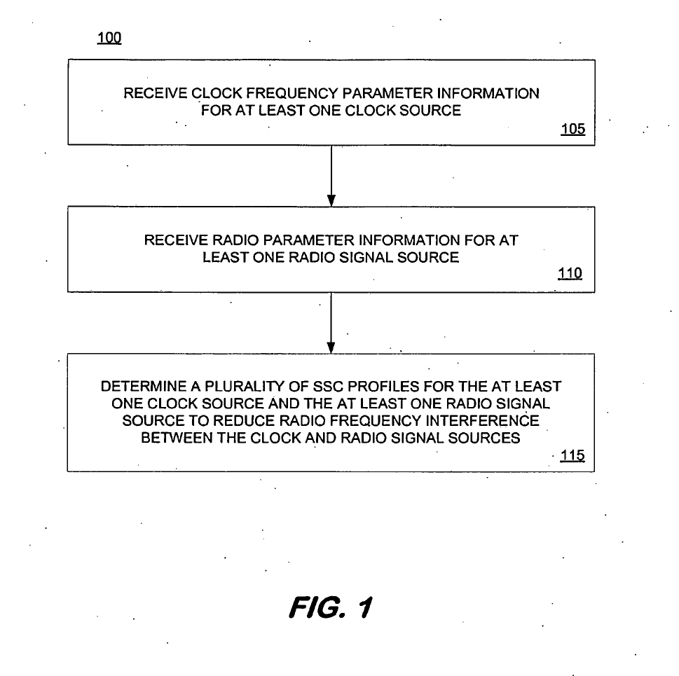

FIG. 1 is a flow diagram of a process 100 related to one embodiment of a radio frequency interference (RFI) mitigation method, tool, system, and apparatus. Process 100 may, in some aspects, provide a mechanism to determine sources of platform radio interference attributable to one or more platform clock sources and to adjust system clock parameters accordingly to reduce or eliminate the RFI caused by the clock sources. At operation 105, radio channel information related to a plurality of platform radios is received. The plurality of radios herein may include (without limitation) a variety of devices that may communicate using a number of different protocols and techniques, including a FM radio, mobile telephony protocols, a global positioning satellite receiver without limitation herein.

At operation 110, clock parameter information associated with one or more system or platform clock signal sources (also referred to as “clock” herein) may be received. The clock parameter information may include the operational frequencies of the clocks, including information regarding the limit(s) of the clock signals. The particular data received at operations 105 and 110 may include, at least, the information needed to determine whether the clock signals from the platform clocks and the radio signals from the radios of the platform have a potential to interfere (e.g., RFI) with each other.

Operation 115 of FIG. 1 includes determining a plurality of SSC profiles for the one or more clock sources and at least one of the radios, where operating the clock sources in accordance with the determined SSC profiles reduces or eliminates the RFI between the clock sources and the radio receivers. A SSC generator device, (sub)system, or module may operate to generate the SSC profiles.

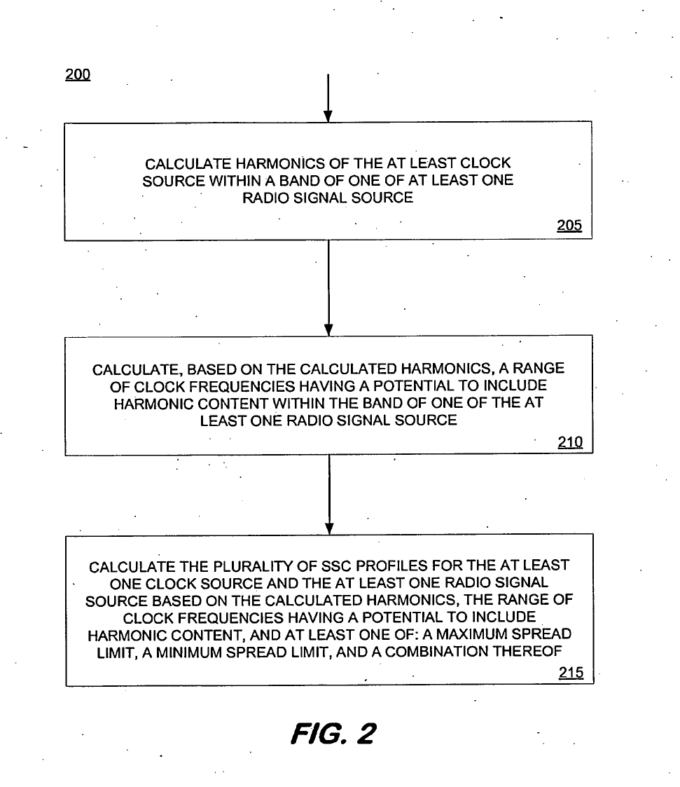

FIG. 2 is a flow diagram for a process 200 associated with reducing or eliminating RFI between at least one platform or system clock source and multiple radios of the same platform. In some aspects, FIG. 2 may be an extension of operation 115 of FIG. 1. It should be further understood by one skilled in the arts associated herewith that operation 115 may be implemented by mechanisms, techniques, and methods other than the example of FIG. 2. In some embodiments, a process for determining a plurality of SSC profiles for the one or more clock sources at operation 115 may include, more, few, other alternative or substitute operations than those particularly disclosed in FIG. 2.

At operation 205, based on information regarding the clock parameters and radio parameters for a platform, system, or device, a calculation of the harmonics for at least one clock source within a band of at least one of the platform clocks is performed. In some embodiments, some processes herein may treat each selected clock independently. In some other embodiments, multiple clocks may be considered collectively in the generation of SSC profiles. Operation 205 may calculate all harmonics of a selected clock that lie within the band of any of the selected radios. In some aspects, multiple radios may be selected to design a spreading profile that reduces clock harmonics in all selected bands simultaneously.

In some embodiments, the harmonic numbers having an interference potential for a given clock and radio are found by the following code snippet:

Ceil(min radio freq/ max clock freq) toFloor(max radio freq/min clock freq)

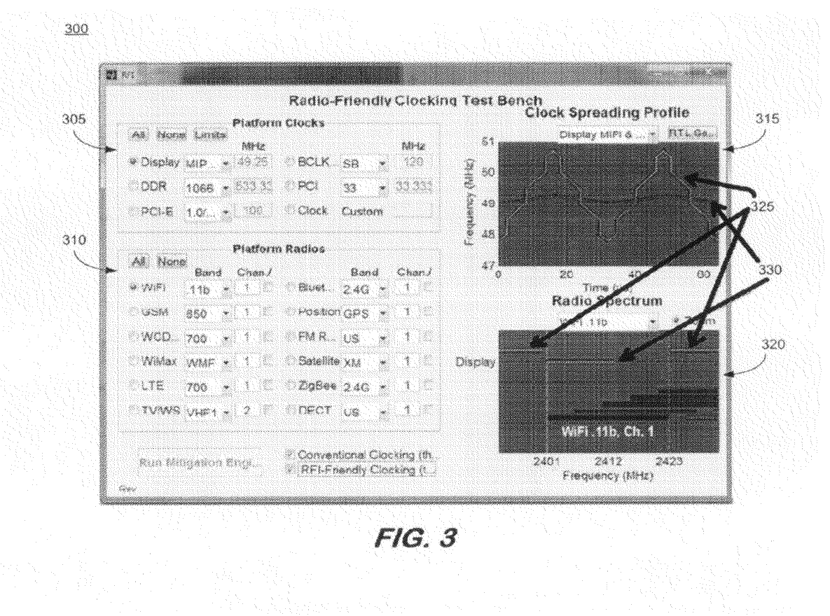

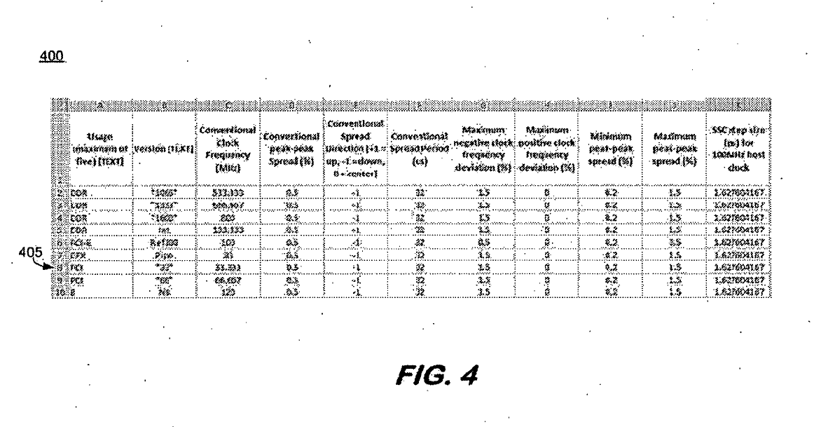

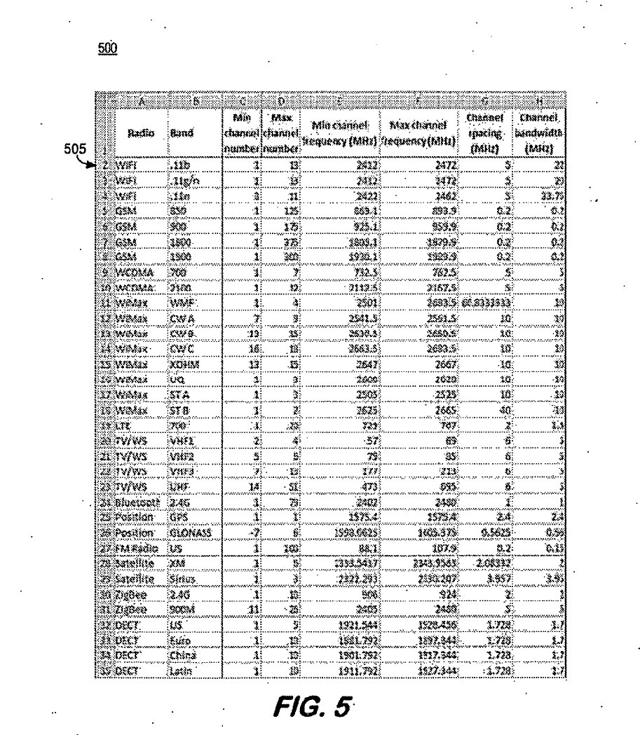

As an example, consider a PCI 33 MHz clock and a WiFi channel 1 as depicted in graphical user interface (GUI) 300 of FIG. 3. GUI 300 includes a presentation of platform clocks at display window 305 and a presentation of platform radios at display window 310. Sample detailed information regarding the platform clocks and radios is listed in the sample clock parameters data shown in FIG. 4 and the radio parameters data shown in FIG. 5, respectively. Based on the code above, calculation of the interference harmonics may include determining the lowest potentially interfering harmonic as ceil[(2412 MHz−22 MHz/2)/33.333 MHz]=ceil[72.33]=73. In this example, since the 72^{nd} harmonic will fall below the lower edge of this WiFi channel, the result is rounded up (“ceil” function in Matlab). The highest harmonic with an interference potential is determined as floor[(2412 MHz+22 MHz/2)/(33.333 MHz−1.5%)]=floor(73.80)=73. The result here is rounded down because the next higher harmonic including downspread will be fully above upper edge of the radio channel. In this example, there is only one harmonic of concern, although for other clock signals and radios there may be more than one potential interference harmonic.

Referring to process 200 at operation 210, the harmonics with a potential for interference are used to calculate the actual range of clock frequencies that may have harmonic content inside the selected radio channel(s) or band(s). The actual range of clock frequencies harmonic numbers that may have harmonic content inside the selected radio channel(s) or band(s) may be found by the following code snippet:

Min radio freq/harmonic number to

Max radio freq/harmonic number

Continuing the example introduced above, the range of clock frequencies of concern is from (2412 MHz−22 MHz/2)/73=32.890 MHz to (2412 MHz+22 MHz/2)/73=33.192 MHz. Here, only a portion of this range is within the conventional PCI-33 spread range of 33.166 to 33.333 MHz, however the entire interference range is retained to allow for alternative spread ranges.

Process 200 continues to operation 215 where a plurality of the radio-friendly SSC profiles are generated for the at least one clock source and the at least one radio receiver, based on the calculations of operations 205 and 210. A number of steps may be involved in generating the radio-friendly clocking profile(s) herein. A number of different approaches may be performed to generate the radio-friendly clocking profile(s), but one such example process will be disclosed herein below to demonstrate the concept of an automatic SSC profile generation engine. It should be appreciated that certain details may be altered or modified within the scope of the present disclosure.

In some embodiments, a candidate profile(s) may be determined. The candidate clocking frequency range may be larger than the range used in a conventional 0.5% downspread range typically used in computing platforms. The candidate range may be defined by the maximum negative clock deviation percentages set in a clock parameters file,such as illustrated in FIG. 4. For the PCI-33 settings shown in the spreadsheet data of FIG. 4 at 405, this range is 33.333 MHz−1.5% to 33.333 MHz (note that the 1.5% negative limit is not based on any specification or known circuit limitation, but is chosen here for demonstration purposes only).

The candidate frequency range may be converted from clock frequencies to clock periods in order to model the behavior of, for example, an integrated SSC generator that uses delay lines to generate spread. The candidate range in this example becomes 30.000 to 30.457 ns.

The SSC generator resolution may be defined by parameters in a clocking parameters file as shown in column K of FIG. 4 for example. In some embodiments this detail may not normally be important for determining interference, but is only for accommodating the limited frequency agility of digitally controlled SSC generators when determining the desired SSC profile(s).

The candidate clocking range may be represented as a one-dimensional array of clock periods. For the purpose of illustration, an SSC generator resolution of 5.0 ps would result in the following matrix for the PCI-33 example used above: [30.000 30.005 30.010 . . . 30.445 30.450 30.455] ns.

The range of potential interference frequencies determined previously may be converted from clock frequencies to clock periods in the same way as the candidate clock frequency range. In the example here, the interference range becomes 1/33.192 MHz=30.128 ns to 1/32.890 MHz=30.404 ns. All elements of the candidate range array described above that are within this interference range are removed from the candidate range array as shown below:
[30.000 30.005 . . . 30.120 30.125 30.405 30.410 . . . 30.450 30.455] ns

In some aspects, the methods and processes herein may allow for (inevitable) spectral spreading by adding a pre-defined margin to either end of the interference range. The amount of margin for real systems may be determined from measured data on spectral spreading and the SSC frequency resolution. A margin of one resolution point is used to illustrate this aspect below:
[30.000 30.005 . . . 30.120 30.410 . . . 30.450 30.455] ns

In some embodiments, the candidate clock range determined above may exceed the maximum allowable spreading. If this is the case, the matrix is truncated appropriately. In the example here, the maximum downspread is 1.5%, equal to the maximum negative clock frequency deviation. Thus, no truncation is necessary. If the maximum downspread had been limited to 1.0% for example, then the candidate clock range could be truncated above 1/(33.333 MHz−1%)=30.303 ns. As an example:
[30.000 30.005 . . . 30.120 ] ns

In one embodiment, the methods and processes herein allow for enforcement of a minimum spread limit to ensure EMI compliance. The elimination of some of the candidate clocking range to avoid radio interference reduces the effective spread of the clock from an EMI perspective. In the example here, the candidate spread is initially 1.5%. After elimination of the interference range, the effective spread is reduced to (1/30.000 ns)−(1/30.120 ns)+(1/30.410 ns)−(1/30.455 ns)=0.181 MHz or 0.543%.

In this example, the remaining effective spread exceeds the minimum limit of 0.2% set in the clock parameters file, so that no action is needed. However, in the instance the remaining spread had been less than the minimum limit, the processed herein may begin to restore frequencies to the candidate range beginning at the edges of the interference range until the minimum spread limit was met. In some embodiments, EMI consideration may outweigh RFI considerations. In some instances having multiple interference ranges (whether arising from a single radio channel, multiple channels or even multiple radios), high priority radios may be exempted from this process at the expense of lower priority radios. Priority assignments can vary by platform type or customer preference.

In this manner, the radio-friendly clocking profile(s) may be generated. Again, it is noted that different approaches may be used in determining the radio-friendly clocking profile(s).

Referring to FIG. 3, an example SSC profile generated in accordance with the present disclosure is depicted in display window 315 at 325. As shown, the generated SSC profile spreads the frequency of the clock signal and includes a number of gaps or notches in the profile. The gaps in the SSC profile are provided so that the clock signal avoids or “jumps” the frequencies that cause RFI with the platform radios. As illustrated, a number of potential RFI frequencies may be accommodated by the SSC profiles generated herein. Display window 320 shows the radio spectrum for a clock signal operating under control of the SSC profile 325. As depicted at 325, the clock operates outside of the radio channel of interest (WiFi 11b, channel 1). Also shown for comparison purposes, a clock operating in accordance with a conventional spread profile depicted at 330 in display window 315 has a frequency that overlaps (i.e., interferes with) the channel of interest as shown in display window 320.

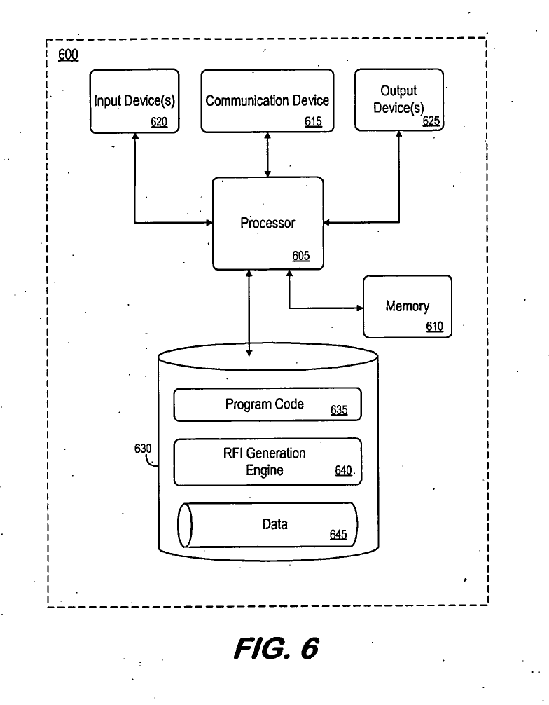

FIG. 6 is a block diagram overview of a system or apparatus 600 according to some embodiments. System 600 may be, for example, associated with any device to implement the methods and processes described herein, including for example client devices and a server of a business service provider that provisions software products. System 600 comprises a processor 605, such as one or more commercially available Central Processing Units (CPUs) in the form of one-chip microprocessors or a multi-core processor, coupled to a communication device 615 configured to communicate via a communication network (not shown in FIG. 6) to another device or system. In the instance system 600 comprises an application server, communication device 615 may provide a means for system 600 to interface with a client device. System 600 may also include a local memory 610, such as RAM memory modules. The system 600 further includes an input device 620 (e.g., a touch screen, mouse and/or keyboard to enter content) and an output device 625 (e.g., a computer monitor to display a user interface element).

Processor 605 communicates with a storage device 630. Storage device 630 may comprise any appropriate information storage device, including combinations of magnetic storage devices (e.g., a hard disk drive), optical storage devices, and/or semiconductor memory devices. In some embodiments, storage device may comprise a database system.

Storage device 630 stores a program code 635 that may provide computer executable instructions for processing requests from, for example, client devices in accordance with processes herein. Processor 605 may perform the instructions of the program 635 to thereby operate in accordance with any of the embodiments described herein. Program code 635 may be stored in a compressed, uncompiled and/or encrypted format. Program code 635 may furthermore include other program elements, such as an operating system, a database management system, and/or device drivers used by the processor 605 to interface with, for example, peripheral devices. Storage device 630 may also include data 645. Data 645, in conjunction with SSC profile generation engine 640, may be used by system 600, in some aspects, in performing the processes herein, such as processes 100 and 200. In some embodiments, data 645 may include clock parameter information records and radio parameter information records. In some embodiments, the clock parameter information records and radio parameter information records may be received from an external source via input devices 620 or communication device 615 that may interface with a communication network.

In some embodiments, components of a system, device, or other apparatus to implement the methods of the present disclosure may include one or more clock signal sources with an adjustable or controllable clock frequency, a source of information regarding limits on valid frequencies for each clock source, a source of information regarding frequencies used by one or more platform radios, and a module with interfaces to the above components for determining the desired clocking parameters and controlling the clock signal source(s). In some aspects, the source of the radio frequency information and the source of the clock information may be the same, though not limited as such. In some embodiments, the sources of the radio and clock information may be a file, whether stored locally or remotely, received as part of a message, received in a data stream, or generated by a device or system including the module for determining the desired clocking parameters and controlling the clock signal sources. In some aspects, the controller module (e.g., a processor, RFI controller “engine”, etc. may be implemented in hardware, firmware, software, and a combination thereof.

In some embodiments, aspects of the present disclosure operate to adjust clock frequency and clock frequency variations to remove clock harmonic energy from radio reception frequencies in use by a platform. It is noted that changes to clock frequency variations herein are not limited to maximum and minimum spreading frequencies, but more generally to the clock spreading profile (i.e., the relationship of clock frequency to time) that generates the spread clock(s). The present disclosure uses information about valid platform clock frequency ranges and radio channels used by the platform to determine optimum clock parameters. The optimum clock parameters may be used to dynamically adjust the platform clock(s) in response to the particular radios operating in the platform.

In some aspects, the present disclosure may be implemented to provide a built-in RFI solution that may accommodate the integration of different components having a wireless radio. In some embodiments, a platform, device, apparatus, or system may automatically invoke one of a plurality of SSC profiles generated in accordance with aspects herein, as needed, during the operation of the platform, device, apparatus, or system. In this manner, uninterrupted and interference free operation of the platform may be achieved.

All systems and processes discussed herein may be embodied in program code stored on one or more computer-readable media. Such media may include, for example, a floppy disk, a CD-ROM, a DVD-ROM, one or more types of “discs”, magnetic tape, a memory card, a flash drive, a solid state drive, and solid state Random Access Memory (RAM) or Read Only Memory (ROM) storage units. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving clock frequency parameter information for at least one clock source;
receiving radio parameter information for at least one radio receiver;
determining, by a processor, one or more spread spectrum clocking (SSC) profiles for the at least one clock source and the at least one radio receiver, each SSC profile to reduce radio frequency interference between the clock and radio receivers; and
storing the SSC profiles.

2. The method of claim 1, wherein each SSC profile includes a gap in at least a part of a frequency range of the clock signal source.

3. The method of claim 1, wherein the determining of the one or more SSC profiles for the at least one clock source and the at least one radio receiver comprises:
calculating harmonics of the at least one clock source within a band of one of the at least one radio receiver;
calculating, based on the calculated harmonics, a range of clock frequencies having a potential to include harmonic content within the band of one of the at least one radio receiver; and
determining of the one or more SSC profiles for the at least one clock source and the at least one radio receiver based on the calculated harmonics, the range of clock frequencies having a potential to include harmonic content, and at least one of: a maximum spread limit, a minimum spread limit, and a combination thereof.

4. The method of claim 1, wherein the at least one clock source is one clock and the at least one radio receiver is a plurality of radio receivers.

5. The method of claim 1, further comprising operating a device including the at least one clock source and the at least one radio signal in accordance with the one or more SSC profiles.

6. The method of claim 5, wherein a specific one the SSC profiles used in operating the device is automatically invoked depending on which of the at least one clock source and which of the at least one radio signal the device is actively using.

7. An apparatus, the apparatus comprising:
at least one radio receiver;
at least one clock source;
a processor to:
receive clock frequency parameter information for the at least one clock source;
receive radio parameter information for the at least one radio receiver; and
determine one or more SSC profiles for the at least one clock source and the at least one radio receiver, each SSC profile to reduce radio frequency interference between the clock and radio receivers; and
a memory to store the SSC profiles.

8. The apparatus of claim 7, wherein each SSC profile includes a gap in at least a part of a frequency range of the clock source.

9. The apparatus of claim 7, wherein the determining of the one or more SSC profiles for the at least one clock source and the at least one radio receiver comprises:
calculating harmonics of the at least one clock source within a band of one of the at least one radio receiver;
calculating, based on the calculated harmonics, a range of clock frequencies having a potential to include harmonic content within the band of one of the at least one radio receiver; and
calculating of the one or more SSC profiles for the at least one clock source and the at least one radio receiver based on the calculated harmonics, the range of clock frequencies having a potential to include harmonic content, and at least one of: a maximum spread limit, a minimum spread limit, and a combination thereof.

10. The apparatus of claim 7, wherein the at least one clock source is one clock and the at least one radio receiver is a plurality of radio receivers.

11. The apparatus method of claim 7, further comprising operating the apparatus including the at least one clock source and the at least one radio signal in accordance with one or more of the SSC profiles.

12. The apparatus of claim 11, wherein a specific one the SSC profiles used in operating the apparatus is automatically invoked depending on which of the at least one clock source and which of the at least one radio signal the apparatus is actively using.

13. A system, the system comprising:
a data storage device;
at least one radio receiver;
at least one controllable clock;
a processor to:
receive clock frequency parameter information for the at least one clock source;
receive radio parameter information for the at least one radio receiver; and
determine one or more SSC profiles for the at least one clock source and the at least one radio receiver, each SSC profile to reduce radio frequency interference between the clock and radio receivers; and
a memory to store the SSC profiles.

14. The system of claim 13, wherein each SSC profile includes a gap in at least a part of a frequency range of the clock source.

15. The system of claim 13, wherein the determining of one or more SSC profiles for the at least one clock source and the at least one radio receiver comprises:
calculating harmonics of the at least one clock source within a band of one of the at least one radio receiver;
calculating, based on the calculated harmonics, a range of clock frequencies having a potential to include harmonic content within the band of one of the at least one radio receiver; and
calculating the one or more SSC profiles for the at least one clock source and the at least one radio receiver based on the calculated harmonics, the range of clock frequencies having a potential to include harmonic content, and at least one of: a maximum spread limit, a minimum spread limit, and a combination thereof.

16. The system of claim 13, wherein the at least one clock source is one clock and the at least one radio receiver is a plurality of radio receivers.

17. The system method of claim 13, further comprising operating the system including the at least one clock source and the at least one radio signal in accordance with the one or more SSC profiles.

18. The system of claim 17, wherein a specific one the plurality of SSC profiles used in operating the system is automatically invoked depending on which of the at least one clock source and which of the at least one radio signal the system is actively using.
